(19) United States
(12) Patent Application Publication
(10) Pub. No.: US 2025/0291984 A1
(43) Pub. Date: Sep. 18, 2025

(54) APPARATUS AND METHOD FOR POWER GRID SIMULATION

(71) Applicant: ELECTRONICS AND TELECOMMUNICATIONS RESEARCH INSTITUTE, Daejeon (KR)

(72) Inventors: Nack Woo KIM, Daejeon (KR); Seok Kap KO, Daejeon (KR); Sang Jun PARK, Daejeon (KR); Hyun Yong LEE, Daejeon (KR); Hyung Ok LEE, Daejeon (KR)

(21) Appl. No.: 18/815,179

(22) Filed: Aug. 26, 2024

(30) Foreign Application Priority Data
Mar. 12, 2024 (KR) 10-2024-0034644

(51) Int. Cl. G06F 30/28; G06F 113/04; G06F 119/02; H02J 3/00

(52) U.S. Cl. CPC G06F 30/28; H02J 3/001; G06F 2113/04; G06F 2119/02; H02J 2203/20

(57) ABSTRACT

Provided is an apparatus for power grid simulation, which includes: an editing module configured to generate a virtual power system based on a digital twin according to a user setting; and a simulation module configured to perform a safety diagnosis simulation on the virtual power system based on at least one state among a physical state, a time state, and a task state of the virtual power system.

### CROSS-REFERENCE TO RELATED APPLICATION

This application claims priority to and the benefit of Korean Patent Application No. 10-2024-0034644, filed on Mar. 12, 2024, the disclosure of which is incorporated herein by reference in its entirety.

### BACKGROUND

### 1. Field of the Invention

Various embodiments disclosed in this document relate to power grid safety diagnosis technology.

### 2. Description of Related Art

Due to the expansion of electric vehicle fast chargers and Internet data centers (IDCs), high-voltage DC loads are increasing. Accordingly, there are increasing attempts to build and operate next-generation transmission/distribution networks by combining the existing AC power grids and DC power grids.

High-voltage power systems provide safety diagnostic monitoring for power grids and power facilities using Internet of Things (IoT) devices and sensors. The safety diagnosis technology includes internal safety diagnosis technology and external safety diagnosis technology for transmission/substation and distribution networks. For example, internal safety diagnosis technology may include pre-detection of malfunctions and failures in an electricity network and detection of errors in system infrastructure (e.g., communication system failures). Additionally, external safety diagnosis technology may include power accidents due to incorrect decisions by internal operators, and damage to the system due to natural disasters and external intrusions, etc.

Power systems may not only have risks due to high power, but may also have failures/errors/safety accidents that may lead to inconveniences/accidents to the users as well as people involved. For example, an unexpected system accident may lead to a chain of accidents in other adjacent systems, causing concerns of a power grid blackout. Furthermore, advanced power systems have a high risk of failures/errors/safety accidents due to the complexity, requiring monitoring through advanced safety diagnosis technology.

### SUMMARY OF THE INVENTION

Power systems require safety diagnosis through advanced simulation for the following reasons.

First, there is an issue with the scale and complexity of a power grid safety diagnosis task. In a power grid system, various accidents occur, such as sudden accidents in an electricity network and infrastructure, as well as human accidents caused by safety operators and physical cascading accidents caused by natural disasters. Therefore, power grid safety diagnosis simulation techniques need to analyze various tasks and provide customized safety diagnosis functions for each field.

Second, there is an issue with the application of virtual-physical simulation technology. Virtual-physical system technology related to the existing power grid system analysis is limitedly used in the field of system safety analysis during initial design or in the field of simulation of accidents that have occurred. Real-time system abnormality monitoring requires more advanced artificial intelligence (AI)-based cyber physical system (CPS) simulation technology. In addition, through real-time power grid analysis, a human and material safety diagnosis solution including worker safety is needed.

To this end, advanced digital technologies, such as AI technology, may be used for safety diagnosis of power systems. For example, by using the latest information and communication technology (ICT) technologies, such as digital twin and virtual-physical technology, diagnosis/monitoring of a power system may be upgraded.

Specifically, a power grid operation and maintenance system may utilize a virtual-physical system based on digital twin for state analysis of a power grid. However, the conventional digital twin-based power grid operation and management system has only limitedly used CPS technology to analyze some states of the power grid and only provided a simulation for specific tasks. Therefore, the conventional digital twin-based power grid operation and management system has not been utilized for the safety diagnosis of the entire power grid, resulting in poor service scalability.

Various embodiments disclosed in this document may provide an apparatus and method for power grid simulation that are capable of performing a safety diagnosis simulation on various states through a virtual power system.

According to an aspect of the present invention, there is provided an apparatus for power grid simulation, which includes: an editing module configured to generate a virtual power system based on a digital twin according to a user setting; and a simulation module configured to perform a safety diagnosis simulation on the virtual power system based on at least one state among a physical state, a time state, and a task state of the virtual power system.

According to an aspect of the present invention, there is provided an apparatus for power grid simulation, which includes: a simulation module configured to perform a safety diagnosis simulation corresponding to at least one state among a physical state, a time state, and a task state of a virtual power system based on a digital twin; and a visualization module that visualizes a result of the safety diagnosis simulation.

According to an aspect of the present invention, there is provided a method for power grid simulation, which includes: generating a virtual power system related to a target power system based on a digital twin; and performing a simulation on at least one state among a physical state, a time state, and a task state of the virtual power system.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating an apparatus for power grid simulation according to an embodiment;

FIG. 2 is a block diagram illustrating a detailed configuration of an editing module according to an embodiment;

FIG. 3 is a block diagram illustrating a detailed configuration of a simulation module according to an embodiment;

FIG. 4 is a block diagram illustrating a detailed configuration of a visualization module according to an embodiment;

FIG. 5 is a flowchart showing a method for power grid simulation according to an embodiment;

FIG. 6 is an exemplary diagram illustrating visualization of a risk diagnosis map of an apparatus for power grid simulation according to an embodiment; and

FIG. 7 is a block diagram illustrating a computer system for implementing a method for power grid simulation according to an embodiment of the present invention.

In relation to the description of the drawings, identical or similar reference numerals may be used for identical or similar components.

### DETAILED DESCRIPTION OF EXEMPLARY EMBODIMENTS

FIG. 1 is a block diagram illustrating an apparatus for power grid simulation according to an embodiment.

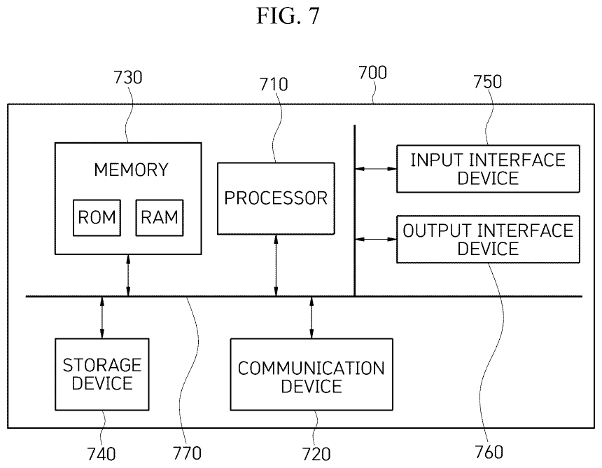

Referring to FIG. 1, an apparatus 100 for power grid simulation according to the embodiment may include an editing module 110, a simulation module 120, a visualization module 130, and a database 140. The editing module 110, the simulation module 120, and the visualization module 130 may be hardware or software modules included in or executed by at least one processor (e.g., a processor 710 in FIG. 7). In an embodiment, the apparatus 100 for power grid simulation may not include some components or may further include additional components. For example, the apparatus 100 for power grid simulation may not include at least one component among the editing module 110, the visualization module 130, or the database 140. In addition, some of the components of the apparatus 100 for power grid simulation may be combined into a single component, but perform the same functions of the components before the combination.

According to an embodiment, the editing module 110 may provide an editing interface for configuring a digital twin-based virtual power system. The editing interface may be provided to add, connect, and set power elements to be included in the virtual power system. The power elements may include at least some power elements among a main transformer, a circuit breaker, a disconnector, a busbar, a grounding device, an insulator, a current transformer, an instrument transformer, a main line, a load, a gateway, and an energy storage system (ESS). For example, the editing interface may include an interface that allows editing of the specifications (e.g., rating, turns ratio) of each power element, input/output signals (e.g., input voltage and current), and connections between power elements.

According to an embodiment, the editing module 110 may generate a virtual power system corresponding to an actual power system based on a digital twin according to user settings. For example, the editing module 110 may generate the virtual power system corresponding to user settings input through the editing interface.

In an embodiment, digital twin technology (or a virtual power system) may support an operation of generating a virtual model corresponding to a physical object and replicating various real data provided through the physical object into the virtual model and performing predictive simulation. Digital twin technology may support predictive diagnosis and control of physical objects through a predictive simulation. Digital twin technology (or a virtual power system) may be configured to include a cyber physical system (CPS). A CPS may be a system that implements phenomena in the actual physical world as a simplified model, analyzes the model based on processed data, and then applies the analysis results back to the physical world.

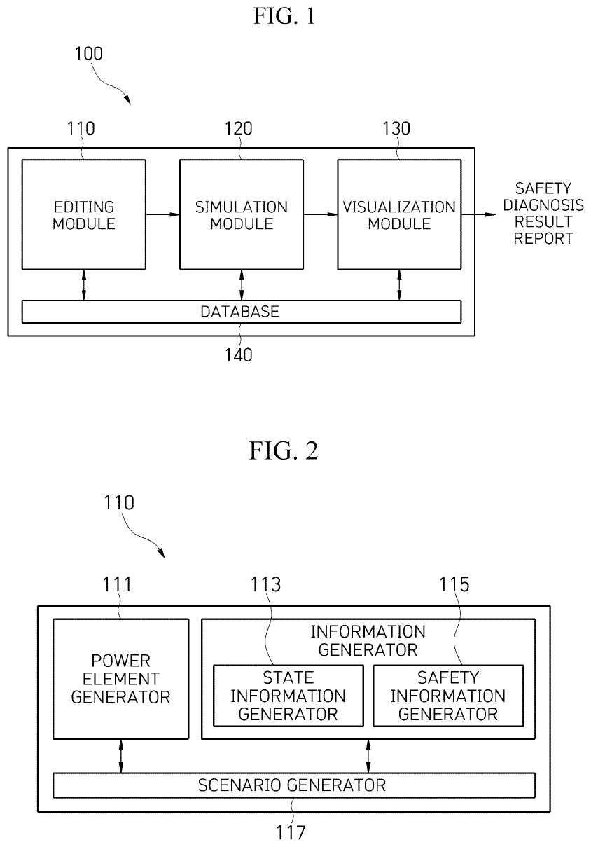

According to an embodiment, the editing module 110 may apply virtual power to the virtual power system according to user settings, and generate training data (e.g., at least one of state information and work safety information) related to lines or facilities included in the virtual power system. The detailed configuration of the editing module 110 will be described below with reference to FIG. 2.

According to an embodiment, the simulation module 120 may train a safety diagnosis simulation related to at least one state of the virtual power system based on the training data generated by the editing module 110.

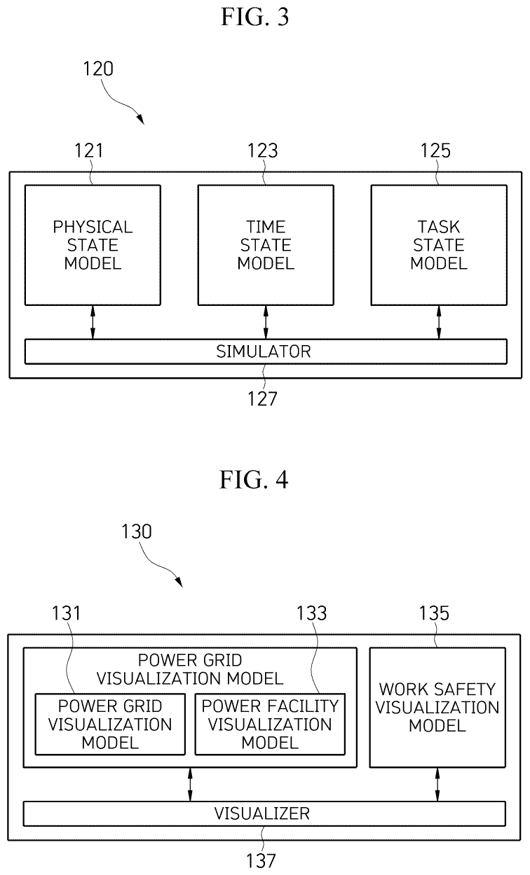

According to an embodiment, the simulation module 120 may simulate at least one state among a physical state, a time state, and a task state of the virtual power system. For example, the physical state may include a physical state related to at least one of heat, fire, and electricity. For example, the time state may include a time state related to at least one of a past state, a present state, and a future state. For example, the task state may include a task state related to at least one of an abnormality diagnosis, a predictive diagnosis, or a classification diagnosis. The detailed configuration of the simulation module 120 will be described below with reference to FIG. 3.

According to an embodiment, the visualization module 130 may visualize the simulation results of the virtual power system by the simulation module 120. As a result, the visualization module 130 may visually output a power system safety diagnosis result. For example, the visualization module 130 may visualize a state related to at least one of a power grid, power facilities, and a work safety state and display the visualized state. As another example, the visualization module 130 may display the degree of risk to power facilities and workers in different colors. As another example, the visualization module 130 may visualize safety diagnosis results for a virtual power system in the form of a risk map. Alternatively, the visualization module 130 may provide safety diagnosis results in the form of a report (e.g., a risk matrix).

The database 140 may include various types of volatile memories or non-volatile memories. For example, the database 140 may include a read only memory (ROM) and a random access memory (RAM). In an embodiment, the database 140 may be located inside or outside the processor, and the database 140 may be connected to the editing module 110, the simulation module 120, and the visualization module 130 through various known means. The database 140 may store various types of data used by at least one component (e.g., the editing module 110, the simulation module 120, and the visualization module 130) of the apparatus 100 for power grid simulation. The data may include, for example, software and input data or output data regarding instructions related thereto. For example, the database 140 may store at least one instruction and related data (e.g., various types of information, each model, and simulation results) for providing a power grid simulation service.

As described above, the apparatus 100 for power grid simulation according to an embodiment may provide a power grid state analysis for the entire virtual power system, as well as performing a safety diagnosis simulation on multiple states including a physical state, a time state, and a task state, and providing related safety diagnosis solutions (e.g. worker safety/design management guides).

FIG. 2 is a block diagram illustrating a detailed configuration of an editing module according to an embodiment.

Referring to FIG. 2, the editing module 110 according to the embodiment may include a power element generator 111, a state information generator 113, a safety information generator 115, and a scenario generator 117. In an embodiment, some of the components of the editing module 110 may be combined into a single component, but perform the same the functions of the corresponding components before the combination.

According to an embodiment, the power element generator 111 may generate a virtual power system including power lines and power facilities according to user settings through an editing interface. The virtual power system may include a plurality of power elements (power lines or power facilities) among a main transformer, a circuit breaker, a disconnector, a busbar, a grounding device, an insulator, a current transformer, an instrument transformer, a main line, a load, a gateway, and an ESS. The virtual power system may be obtained by modeling an actual power system (or a power grid), which has already been implemented or is in the design stage, based on a digital twin.

According to an embodiment, the state information generator 113 may apply virtual power according to user settings to the virtual power system. The state information generator 113 may generate state information of the virtual power system in which the virtual power is applied. For example, the state information may include state information related to at least one of a physical state, a time state, or a task state of lines and facilities included in the virtual power system. The state information may further include behavioral state information of an operator in each state. For example, the physical state may include a physical state related to at least one of heat, fire, and electricity. For example, the time state may include a time state related to at least one of a past state, a present state, and a future state. For example, the task state may include a task state related to at least one of an abnormality diagnosis, a predictive diagnosis, or a classification diagnosis.

According to an embodiment, the safety information generator 115 may generate work safety information on at least one of an access restriction time, an access restriction area, an access restriction distance, or an access restriction space for the virtual power system according to user settings. The user settings related to the safety information generator 115 may involve for example, at least one work restriction condition among system operation guidelines for worker safety, worker safety management settings, and worker safety management settings based on safety accident management regulations and procedures.

According to an embodiment, the scenario generator 117 may generate a safety diagnosis scenario (or safety diagnosis data) according to user settings based on at least one of state information and work safety information.

According to one embodiment, the user may input, into the editing module 110 (e.g., the editing interface) a first scenario setting for diagnosing a state and a risk level of power facilities included in the virtual power system upon start-up and a shutdown of the power system. For example, the set time state may be the start-up and the shutdown of the power system. The set task state may be a diagnosis task of a state and a risk level of power facilities. In this case, the scenario generator 117 may generate a first safety diagnosis scenario for safety diagnosis of the state and the risk level of power facilities included in the virtual power system upon start-up and shutdown of the power system according to the first scenario settings. The first safety diagnosis scenario may include response measures according to the state and the risk level of each power facility upon start-up and shutdown of the power system. The response measures may include, for example, the distance of separation from each power facility in a normal state and an abnormal state of the power facilities, and an action plan for an accident in an abnormal state.

According to one embodiment, the user may input, into the editing module 110, a second scenario setting for safety diagnosis in the event of an electrical fire. In this case, the scenario generator 117 may generate a second safety diagnosis scenario including worker separation distance data for when an electrical fire occurs in the power system. According to an embodiment, the user may input, into the editing module 110, a third scenario setting for safety diagnosis in the event of insulation breakdown of the power system due to flashover voltage in an abnormal arc occurrence state. In this case, the scenario generator 117 may generate a third safety diagnosis scenario including worker separation distance data according to the state and the risk level of the power system.

FIG. 3 is a block diagram illustrating a detailed configuration of a simulation module according to an embodiment.

Referring to FIG. 3, the simulation module 120 according to the embodiment may include a physical state model 121, a time state model 123, a task state model 125, and a simulator 127. In an embodiment, some of the components of the simulation module 120 may be combined into a single component, but perform the same functions of the corresponding components before the combination. For example, the physical state model 121, the time state model 123, and the task state model 125 may be included in the simulator 127 or the database 140. In an embodiment, the simulation module 120 may be modeled by learning the training data (e.g., state information, work safety information, and safety diagnostic scenarios) from the editing module 110.

According to an embodiment, the physical state model 121 may be a state model for analyzing a physical state related to at least one of heat, fire, and electricity. The physical state model 121 may include at least one physical state model among a thermal state model for analyzing heat generation of facilities included in the power system; a fire state model for analyzing fire occurrence in the power system due to heat or arc; and an electricity state model for analyzing operation states of lines and nodes of the power system.

According to an embodiment, the time state model 123 may be a state model for diagnosing or predicting a time state related to at least one of a past state, a future state, or a current state based on past data related to a cyber/real power system.

According to an embodiment, the task state model 125 may be a state model for determining a diagnostic task related to at least one of an abnormality, a prediction, or a classification. For example, the task state model 125 may include at least one diagnostic model among a future state diagnosis model based on past data; a current state diagnosis model for missing nodes/lines based on past data; and a specific past condition diagnostic model based on past data.

According to an embodiment, the simulator 127 may perform a safety diagnosis simulation on at least one state of the virtual power system using the physical state model 121, the time state model 123, and the task state model 125. For example, the simulator 127 may simulate a safety diagnosis related to heat, fire, or electricity of a virtual power system according to a safety diagnosis scenario using the physical state model 121. The simulator 127 may simulate a safety diagnosis related to a time state according to a safety diagnosis scenario using the time state model 123. The simulator 127 may simulate a safety diagnosis (e.g., an abnormality diagnosis, a predictive diagnosis, and a classification diagnosis) related to a task state according to a safety diagnosis scenario using the task state model 125. As another example, the simulator 127 may predict the occurrence of abnormalities in a further power system through specific power generation and a load on the lines and nodes of the virtual power system according to the safety diagnosis scenario. In this regard, the simulator 127 may refer to state information and work safety information of the virtual power system for a simulation.

FIG. 4 is a block diagram illustrating a detailed configuration of a visualization module according to an embodiment.

Referring to FIG. 4, the visualization module 130 according to the embodiment may include facility safety visualization models 131 and 133, a work safety visualization model 135, and a visualizer 137. The visualizer 137 may visualize simulation results in the form of at least one of text, symbols, or images. In an embodiment, some of the components of the visualization module 130 may be combined into a single component, but perform the same functions of the components before the combination. For example, the facility safety visualization models 131 and 133 may include a power grid visualization model 131 and a power facility visualization model 133.

The power grid visualization model 131 may visualize the at least one state related to at least one power grid among an AC network, a DC network, and an AC/DC mixed network included in a target power system.

The power facility visualization model 133 may visualize a time state and a task state based on a physical state related to at least one of computational fluid dynamics, fire dynamics, or heat transfer.

The work safety visualization model 135 may be provided to visualize facility maintenance and diagnosis of workers. For example, the work safety visualization model 135 may visualize work safety data related to at least one of an access restriction time, an access restriction area, a separation distance, or an access restriction space for a target power system by workers.

The work safety visualization model 135 may be used to prevent workers from entering a specific area at a specific time or to monitor restricted areas based on the level of risk by visually displaying the work safety data.

According to an embodiment, the visualizer 137 may visualize results of the safety diagnosis simulation using the power grid visualization model 131, the power facility visualization model 133, and the work safety visualization model 135. For example, the visualizer 137 may generate a risk map of power facility/power grid based on simulation results of a virtual power system. For example, the visualizer 137 may display a risk map of a virtual power system in two or three dimensions, in which the risk levels of power facilities and workers is displayed in colors according to the risk levels. As another example, the visualizer 137 may provide safety diagnosis results in the form of a report (e.g., a risk matrix). For example, the risk matrix may grade and visualize the potential risks (e.g., the number of failures or the probability of failure) and the impact of risks for power elements included in the virtual power system.

As described above, the visualization module 130 according to the embodiment may visually express the results of safety diagnosis simulation, thereby supporting monitoring of specific times and areas accessible to workers, and execution of safe work instructions based on the monitoring results.

In addition, the apparatus 100 for power grid simulation according to an embodiment may generate a safety diagnosis scenario for a virtual power system, simulate the virtual power system based on the generated safety diagnosis scenario, and visualize the simulation results, thereby greatly improving convenience of safety diagnosis.

Furthermore, the apparatus 100 for power grid simulation according to an embodiment may collectively process power grid and power facility safety diagnosis, worker safety diagnosis, and the like through the CPS simulation apparatus, and also allow a power grid safety manager to perform a real-time diagnostic evaluation on the operating state not only for workers but also for the entire power grid.

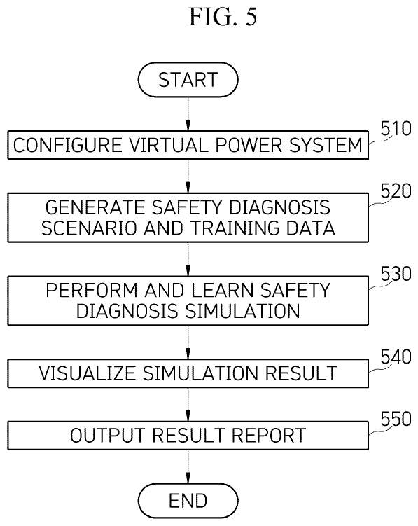

FIG. 5 is a flowchart showing a method for power grid simulation according to an embodiment.

Referring to FIG. 5, in operation 510, the apparatus 100 for power grid simulation may generate a virtual power system for a safety diagnosis based on a digital twin. For example, when a user inputs a configuration (e.g., power elements and settings thereof) of a virtual power system through the editing module 110, the editing module 110 may generate a virtual power system corresponding to the user settings.

In operation 520, when a scenario setting is input by the user, the apparatus 100 for power grid simulation may generate a safety diagnosis scenario and training data according to the scenario settings. For example, the editing module 110 may generate state information and work safety information of the virtual power system related to the scenario settings (or a safety diagnosis scenario). For example, the safety diagnosis scenario may be to determine a voltage level, a phase, and a presence of an abnormality for each line of the power system.

In operation 530, the apparatus 100 for power grid simulation may learn a safety diagnosis simulation of the power system based on the safety diagnosis scenario and the training data. For example, the simulation module 120 may select a model according to the safety diagnosis scenario and train the selected model for a safety diagnosis simulation based on the training data. The simulation module 120 may perform a safety diagnosis simulation according to the safety diagnosis scenario using a model modeled with the training results.

In operation 540, the apparatus 100 for power grid simulation may visualize safety diagnosis simulation results using a visualization model corresponding to a task state. For example, the visualization module 130 may visualize safety diagnosis simulation results using a visualization model according to a task state. As another example, the visualization module 130 may generate a risk map by visualizing results of the safety diagnosis simulation.

In operation 550, the apparatus 100 for power grid simulation may generate and output a result report based on the simulation results. For example, the result report may include response measures (or guidelines) for safety diagnosis of workers. The result report may include, for example, a risk matrix.

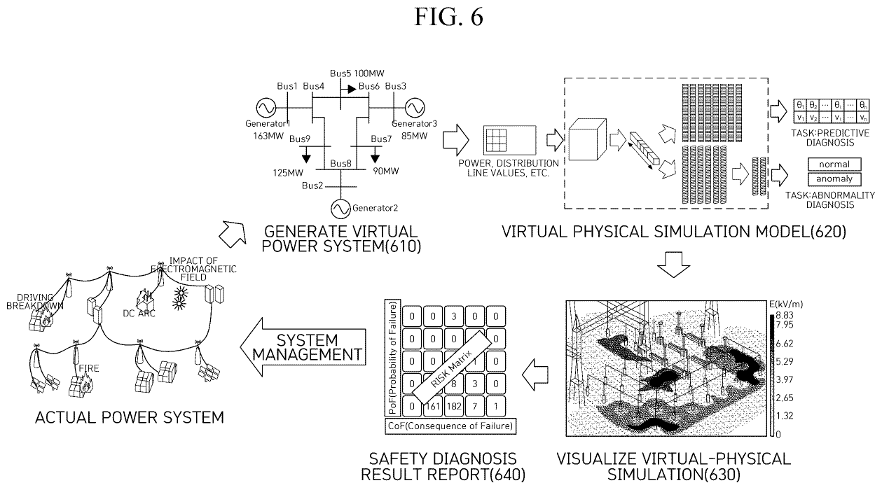

FIG. 6 is an exemplary diagram illustrating visualization of a risk diagnosis map of an apparatus for power grid simulation according to an embodiment.

In operation 610, the apparatus 100 for power grid simulation may generate a virtual power system corresponding to an actual power system according to user settings through the editing module 110.

In operation 620, the apparatus 100 for power grid simulation may obtain state information and work safety information of the virtual power system according to a safety diagnosis scenario, and learn the obtained information, thereby constructing a simulation model (e.g., a physical state model 121, a time state model 123, and a task state model 125). The simulation model may include models for performing a predictive diagnosis task and an abnormality diagnosis task on the voltages of lines within the virtual power system by the simulator 127. The simulation model may include models for constructing a risk map based on a threshold for an abnormality diagnosis.

In operation 630, the apparatus 100 for power grid simulation may visualize results of a virtual-physical simulation in the form of a risk map, for example.

In operation 640, the apparatus 100 for power grid simulation may generate a safety diagnosis result report based on the threshold for the abnormality diagnosis. For example, the safety diagnosis result may include a risk matrix that may grade and visualize the potential risks (e.g., the number of failures or the probability of failure) and the impact of risks for power elements included in the virtual power system. Accordingly, workers may perform safe diagnosis and operation/management of the actual power system based on the safety diagnosis result report.

As described above, the apparatus 100 for power grid simulation according to an embodiment generates a safety diagnosis scenario for a virtual power system, simulates the virtual power system based on the generated safety diagnosis scenario, and visualizes the simulation results, thereby greatly improving safety diagnosis.

In addition, the apparatus 100 for power grid simulation according to an embodiment may collectively process power grid and power facility safety diagnosis, worker safety diagnosis, and the like through the CPS simulation apparatus, and allow a power grid safety manager to perform diagnostic evaluation on an operating state not only for workers but also for the entire power grid.

FIG. 7 is a block diagram illustrating a computer system for implementing a method for power grid simulation according to an embodiment.

Referring to FIG. 7, a computer system 700 (e.g., the apparatus 100 for power grid simulation shown in FIG. 1) may include at least one of a processor 710 (e.g., the editing module 110, the simulation module 120, and the visualization module 130 shown in FIG. 1), a memory 730 (e.g., the database 140 shown in FIG. 1), an input interface device 750, an output interface device 760, and a storage device 740 that communicate through a bus 770. The computer system 700 may further include a communication device 720 coupled to a network. The processor 710 may be a central processing unit (CPU) or a semiconductor device for executing instructions stored in the memory 730 and/or storage device 740. The memory 730 and the storage device 740 may include various forms of volatile or nonvolatile media. For example, the memory 730 may include a read only memory (ROM) or a random access memory (RAM). In an embodiment, the memory 730 may be located inside or outside the processor 710 and may be connected to the processor 710 through various known means. The memory 730 may include various forms of volatile or nonvolatile media, for example, may include a ROM or a RAM.

The various embodiments of the disclosure and terminology used herein are not intended to limit the technical features of the disclosure to the specific embodiments, but rather should be understood to cover all modifications, equivalents, and alternatives falling within the spirit and scope of the invention. Like numbers refer to like elements throughout the description of the drawings. The singular forms preceded by “a,” “an,” and “the” corresponding to an item are intended to include the plural forms as well unless the context clearly indicates otherwise. In the disclosure, a phrase such as “A or B,” “at least one of A and B,” “at least one of A or B,” “A, B or C,” “at least one of A, B and C,” and “at least one of A, B, or C” may include any one of the items listed together in the corresponding phrase, or any possible combination thereof. Terms such as “first,” “second,” etc. are used to distinguish one element from another and do not modify the elements in other aspects (e.g., importance or sequence). When one (e.g., a first) element is referred to as being “coupled” or “connected” to another (e.g., a second) element with or without the term “functionally” or “communicatively,” it means that the one element is connected to the other element directly (e.g., by wire), wirelessly, or via a third element.

As used herein, the term “module” may include units implemented in hardware, software, or firmware, and may be interchangeably used with terms such as “logic,” “logic block,” “component,” or “circuit.” The module may be an integrally configured component or a minimum unit or part of the integrally configured component that performs one or more functions. For example, according to one embodiment, the module may be implemented in the form of an application-specific integrated circuit (ASIC).

The various embodiments of the present disclosure may be realized by software (e.g., a program) including one or more instructions stored in a storage medium (e.g., the database 140, such as an internal memory or external memory) that can be read by a machine (e.g., the apparatus 100 for power grid simulation). For example, a processor (e.g., the processor 710) of the machine (e.g., the apparatus 100 for power grid simulation) may invoke and execute at least one instruction among the stored one or more instructions from the storage medium. Accordingly, the machine operates to perform at least one function in accordance with the invoked at least one command. The one or more instructions may include codes generated by a compiler or codes executable by an interpreter. The machine-readable storage medium may be provided in the form of a non-transitory storage medium. Here, when a storage medium is referred to as “non-transitory,” it can be understood that the storage medium is tangible and does not include a signal (for example, electromagnetic waves), but rather that data is semi-permanently or temporarily stored in the storage medium.

According to one embodiment, the methods according to the various embodiments disclosed herein may be provided in a computer program product. The computer program product may be traded between a seller and a buyer as a product. The computer program product may be distributed in the form of a machine-readable storage medium (e.g., a compact disc read only memory (CD-ROM)), or may be distributed directly between two user devices (e.g., smartphones) through an application store (e.g., Play Store™), or online (e.g., downloaded or uploaded). In the case of online distribution, at least a portion of the computer program product may be stored at least semi-permanently or may be temporarily generated in a machine-readable storage medium, such as a memory of a server of a manufacturer, a server of an application store, or a relay server.

Components according to various embodiments of the disclosure 0 may be implemented in the form of software or hardware, such as a digital signal processor (DSP), a field programmable gate array (FPGA) or an application specific integrated circuit (ASIC), and may perform predetermined functions. The “elements” are not limited to meaning software or hardware. Each of the elements may be configured to be stored in a storage medium capable of being addressed and configured to execute one or more processors. For example, the elements may include elements such as software elements, object-oriented software elements, class elements, and task elements, processes, functions, attributes, procedures, subroutines, segments of a program code, drivers, firmware, microcode, circuits, data, databases, data structures, tables, arrays, and variables.

According to the various embodiments, each of the above-described elements (e.g., a module or a program) may include a singular entity or a plurality of entities. According to various embodiments, one or more of the above described elements or operations may be omitted, or one or more other elements or operations may be added. Alternatively or additionally, a plurality of elements (e.g., modules or programs) may be integrated into one element. In this case, the integrated element may perform one or more functions of each of the plurality of elements in a manner the same as or similar to that performed by the corresponding element of the plurality of components before the integration. According to various embodiments, operations performed by a module, program, or other elements may be executed sequentially, in parallel, repeatedly, or heuristically, or one or more of the operations may be executed in a different order, or omitted, or one or more other operations may be added.

As is apparent from the above, according to various embodiments of the disclosure, a safety diagnosis simulation on various states can be performed through a virtual power system. In addition, various effects that can be directly or indirectly identified through this document can be provided.

What is claimed is:

1. An apparatus for power grid simulation, comprising:
an editing module configured to generate a virtual power system based on a digital twin according to a user setting; and
a simulation module configured to perform a safety diagnosis simulation on the virtual power system based on at least one state among a physical state, a time state, and a task state of the virtual power system.

2. The apparatus of claim 1, wherein:
the editing module generates training data using the virtual power system; and
the simulation module trains a safety diagnosis simulation related to the at least one state based on the training data.

3. The apparatus of claim 1, wherein the editing module is configured to:
provide an editing interface for adding, connecting, and setting power elements to be included in the virtual power system; and
generate the virtual power system corresponding to the user setting input through the editing interface,
wherein the power elements include at least some power elements among a main transformer, a circuit breaker, a disconnector, a busbar, a grounding device, an insulator, a current transformer, an instrument transformer, a main line, and a load.

4. The apparatus of claim 1, wherein the editing module includes:
a first generator that, according to the user setting related to virtual power, applies the virtual power to generate at least one of state information among facility state information of power elements included in the virtual power system or operation state information of the power elements;
a second generator that, according to the user setting related to work restriction conditions, generates work safety information regarding at least one of an access restriction time, an access restriction area, an access restriction distance, or an access restriction space for an actual power system corresponding to the virtual power system; and
a third generator that generates a safety diagnosis scenario for the actual power system according to the user setting based on the at least one of state information and the work safety information.

5. The apparatus of claim 1, wherein the simulation module includes a first state model for analyzing a physical state related to at least one of heat, fire, and electricity, and performs a simulation on the physical state through the first state model.

6. The apparatus of claim 1, wherein the simulation module includes a second state model for diagnosing or predicting a time state related to at least one of a past state, a future state, and a current state based on past data related to the virtual power system, and performs a simulation on the time state through the second state model.

7. The apparatus of claim 1, wherein the simulation module includes a third state model for analyzing a diagnostic task related to at least one of an abnormality diagnosis, a predictive diagnosis, or a classification diagnosis, and performs a simulation on the task state through the third state model.

8. The apparatus of claim 1, further comprising a visualization module that visualizes a simulation result for the virtual power system.

9. The apparatus of claim 8, wherein the visualization module includes at least one model among:
a first model for visualizing at least one power grid among an alternating current (AC) network, a direct current (DC) network, and an AC/DC mixed network included in the virtual power system;
a second model for visualizing a time state and a task state based on a physical state related to at least one of computational fluid dynamics, fire dynamics, or heat transfer; or
a third model for visualizing work safety data related to at least one of an access restriction time, an access restriction area, an access restriction distance, or an access restriction space of the virtual power system, and
the visualization module visualizes the simulation result through the at least one model.

10. An apparatus for power grid simulation, comprising:
a simulation module configured to perform a safety diagnosis simulation corresponding to at least one state among a physical state, a time state, and a task state of a virtual power system based on a digital twin; and
a visualization module that visualizes a result of the safety diagnosis simulation.

11. The apparatus of claim 10, wherein the simulation module includes a first state model for analyzing a physical state related to at least one of heat, fire, and electricity, and performs a safety diagnosis simulation corresponding to the physical state through the first state model.

12. The apparatus of claim 10, wherein the simulation module includes a second state model for diagnosing or predicting a time state related to at least one of a past state, a future state, and a current state based on past data related to an actual power system corresponding to the virtual power system, and performs a safety diagnosis simulation corresponding to the time state through the second state model.

13. The apparatus of claim 10, wherein the simulation module includes a third state model for analyzing a diagnostic task related to at least one of an abnormality diagnosis, a predictive diagnosis, or a classification diagnosis, and performs a safety diagnosis simulation on the task state through the third state model.

14. The apparatus of claim 10, wherein the visualization module includes a first model for visualizing the at least one state related to at least one power grid among an alternating current (AC) network, a direct current (DC) network, and an AC/DC mixed network included in the virtual power system.

15. The apparatus of claim 10, wherein the visualization module includes a second model for visualizing a time state and a task state based on a physical state related to at least one of computational fluid dynamics, fire dynamics, or heat transfer.

16. The apparatus of claim 10, wherein the visualization module includes a third model for visualizing work safety data related to at least one of an access restriction time, an access restriction area, an access restriction distance, or an access restriction space of the virtual power system.

17. The apparatus of claim 10, wherein the visualization module visualizes a result of the safety diagnosis simulation in a form of a risk map.

18. The apparatus of claim 10, wherein the visualization module displays a degree of risk to power facilities and workers from the result of the safety diagnosis simulation in different colors.

19. The apparatus of claim 10, wherein the visualization module generates a risk matrix for each power element of the virtual power system based on the result of the safety diagnosis simulation.

20. A method for power grid simulation, comprising:
generating a virtual power system related to a target power system based on a digital twin; and
performing a simulation on at least one state among a physical state, a time state, and a task state of the virtual power system.
